(19) United States
(12) Patent Application Publication
(10) Pub. No.: US 2025/0191276 A1
(43) Pub. Date: Jun. 12, 2025

(54) HYBRID RAY TRACING AND CORRELATION VECTORS FOR 3D BUILDING MODELING

(71) Applicant: oneNav, Inc., Sunnyvale, CA (US)

(72) Inventor: Paul McBurney, Palo Alto, CA (US)

(21) Appl. No.: 18/974,587

(22) Filed: Dec. 9, 2024

Related U.S. Application Data
(60) Provisional application No. 63/608,816, filed on Dec. 11, 2023.

(51) Int. Cl. G06T 15/06; G01S 19/42

(52) U.S. Cl. CPC G06T 15/06; G01S 19/42

(57) ABSTRACT

Methods and systems for collecting data about GNSS signals in an environment to estimate parameters about objects in the environment. In one embodiment, GNSS signals are received and processed to obtain a set of one or correlation vectors that include both line of sight (LOS) signals and diffracted signals. The LOS signals and diffracted signals are processed to derive geometric measurements that can be used to determine the height of a building in the environment or other aspects of the building. In another embodiment, the collected data can be used to improve or correct a ray tracing model for the environment.

### CROSS-REFERENCE TO RELATED APPLICATIONS

This application claims the benefit of and priority to U.S. Provisional patent application No. 63/608,816, which was filed on Dec. 11, 2023, and this U.S. provisional patent application is hereby incorporated herein by reference.

### BACKGROUND

This disclosure relates to navigation systems, such as global navigation satellite system (GNSS) receivers that receive GNSS signals from GNSS satellites and use those signals to determine their position.

Urban canyons cause problems for GNSS receivers because the tall buildings which line the streets of cities often block direct, line of sight signals from reaching the GNSS receiver. Moreover, reflected GNSS signals, that are reflected off the buildings, can require further processing in the GNSS receiver to distinguish between line of sight (LOS) signals and non-line of sight (NLOS) signals. Further, diffraction of the signals, in effect, creates additional signals that complicate any signal processing of received GNSS signals. As a result, position location using GNSS signals in urban canyons can be inaccurate or even impossible to achieve. This inaccuracy can result in situations in which a driver of a taxi service (e.g., Uber) is directed to the wrong side of the street by the GNSS receiver of the potential passenger.

This problem has been studied and some solutions have been proposed, including the solutions described in U.S. Pat. No. 9,562,770 (inventor: Lionel J. Garin) and US published patent application publication No. US 2021/0325548. In these prior approaches, ray tracing techniques can be used to create a database of expected signal reception patterns based on the reflections due to the buildings in an urban canyon environment. The expected signal reception patterns, over a set of grid positions in the environment, can then be compared with the received signal reception patterns and this comparison can be used to provide a position of the GNSS receiver. However, these approaches suffer from the inaccuracy associated with the heights of the buildings, as well other building parameters like the building surface reflectivity, and building shape and location, in a typical urban canyon environment. While surveying approaches (e.g., with cameras) can estimate the facade dimensions (width and length) of the buildings that are near the surface, it is difficult for such approaches to accurately estimate the height of the buildings and building characteristics above the range of the camera. This disclosure provides solutions to this and other problems encountered by prior approaches that may be used in such environments.

### SUMMARY OF THE DESCRIPTION

One aspect of this disclosure relates to the collection of information, for example in the form of correlation vectors, in an environment (such as an urban canyon) and using this collected information to improve or correct ray tracing models that attempt to predict GNSS signals in the environment. In one embodiment according to this aspect, a set of one or more correlation vectors are collected by a GNSS receiver that is positioned at known, controlled locations in the environment. The collected correlation vectors can then be used to correct or improve a ray tracing model of the environment. For example, the collected correlation vectors can be used to add or modify amplitude data and timing delay data into the ray tracing model (e.g., so that the ray tracing model matches the observations from the collected correlation vectors). The improved or corrected ray tracing model can then be used in pattern matching operations to provide an estimated position of a GNSS receiver. The pattern matching operations can be similar to those described in US published patent application publication No. US 2021/0325548 or other pattern matching methods known in the art for processing received GNSS signals.

In one embodiment, the added amplitude data and timing data (e.g., from the collected correlation vectors) can include data about diffraction such as diffracted GNSS signals caused by the edge (e.g., roof's edge) of a building. For example, a ray tracing model can be modified to add such data about diffracted GNSS signals, and then the improved ray tracing model can be used in, for example, pattern matching operations to help determine a position of a GNSS receiver.

In one embodiment, the collected information can be used to provide an estimate of the height of each building or other obstruction in the environment (which blocks or attenuates GNSS signals). The estimate can be based on a set of collected correlation vectors from controlled locations around the building or other obstruction, and the estimated heights can be used in one or more ray tracing models to create an expected signal reception set of data in the environment based upon the estimated heights.

In one embodiment, the collected information can be used to correct or improve a building's façade surface model. In one embodiment, the collected information can be used to correct a building distance from an estimated location. In one embodiment, the collected information can be used to detect a slanted building surface.

In one embodiment, the collected information may be derived from a crowd source, such as a crowd sourced set of correlation vectors. The crowd sourced set of correlation vectors can be received from a crowd (e.g., many GNSS receivers) located in an environment (e.g., an urban canyon), and each of these crowd sourced correlation vectors can be corrected based on a post processed position and clock bias estimate for each source. The amplitude estimates in each set of crowd sourced correlation vectors (after any corrections) can be summed at a common codephase (thereby aligning the different correlation vectors from each source in the crowd).

In one embodiment, a data processing system (which may be a set of servers, etc.) can be used to implement an embodiment and can comprise a network interface to receive a set of one or more correlation vectors derived from received GNSS signals in an environment from one or more GNSS satellites (SVs), the set of one or more correlation vectors collected with data that provides a known location and GNSS system time and ephemeris of the one or more GNSS SVs. The data processing system can include one or more processing systems coupled to the network interface, the one or more processing systems to determine, from the received set of one or more correlation vectors, a first set of data; and the one or more processing systems can be configured to generate a ray tracing model based upon the first set of data and data about objects in a vicinity of the environment, the ray tracing model describing the expected behavior of received GNSS signals in the environment; and the system can include one or more storage systems coupled to the one or more processing systems, the one or more storage systems to store the ray tracing model. In one embodiment, the first set of data can comprise data estimating one or more heights of one or more buildings in the environment and wherein the environment is an urban or suburban canyon that includes one or more buildings that obstruct GNSS signals from GNSS SVs. In one embodiment, the first set of data includes corrections or additions to the ray tracing model, and wherein the additions include one or more amplitudes and phase data for diffractions determined from the collected set of one or more correlation vectors. In one embodiment, the ray tracing model provides shadow matching assistance data that is for use in pattern matching operations to compute one or more locations of GNSS receivers in the environment. In one embodiment, the first set of data includes an estimate of one or more heights of one or more buildings in the environment, the estimate of the one or more heights derived from one or more observed LOS signals and one or more observed diffraction signals in the set of one or more correlation vectors.

The various embodiments described herein can be implemented in a GNSS receiver that uses either time domain correlation (with a bank of time domain correlators) or frequency domain correlation (with a frequency domain correlation system such as one of the systems shown in U.S. Pat. No. 11,686,855 which patent is hereby incorporated herein by reference. The various embodiments described herein may be implemented in a GNSS receiver that receives and processes GNSS signals in the L1 radio frequency (RF) band and in the L5 RF band or may be implemented in a GNSS receiver that receives and processes GNSS signals in only the L5 RF band; in the case of the L5 only receiver, such receiver may use one or more of the secondary code acquisition methods described in U.S. Pat. No. 11,821,993 which patent is hereby incorporated herein by reference. Such a GNSS receiver can receive shadow matching assistance data that is derived from an improved ray tracing model (that has been improved using one or more of the embodiments described herein), and the GNSS receiver can determine its position using pattern matching methods and the improved ray tracing model.

The aspects and embodiments described herein can include non-transitory machine readable media that can store executable computer program instructions that when executed cause one or more data processing systems (e.g., one or more GNSS processing systems or processing logic in a GNSS receiver) to perform the methods described herein when the computer program instructions are executed by the one or more data processing systems. The instructions can be stored in non-transitory machine readable media such as in dynamic random access memory (DRAM) which is volatile memory or in nonvolatile memory, such as flash memory or other forms of memory. The aspects and embodiments described herein can also be in the form of data processing systems, such as GNSS receivers or portions of GNSS receivers, that are built or programmed to perform these methods. For example, a data processing system can be built with hardware logic to perform these methods or can be programmed with a computer program to perform these methods and such a data processing system can be considered a GNSS processing system or GNSS processing logic. For example, a GNSS processing system or GNSS processing logic can be a microprocessor or a microcontroller.

The above summary does not include an exhaustive list of all embodiments and aspects in this disclosure. All systems, media, and methods can be practiced from all suitable combinations of the various aspects and embodiments summarized above and also those disclosed in the detailed description below.

### BRIEF DESCRIPTION OF THE DRAWINGS

The embodiments described herein are illustrated by way of example and not limitation in the figures of the accompanying drawings in which like references indicate similar elements.

FIG. 1A shows an example of an embodiment which can be used to determine a height of a building based upon data contained in a set of correlation vectors.

FIG. 1B shows an example of the geometry of the embodiment illustrated in FIG. 1A.

FIG. 2 is a flow chart that illustrates a method according to an embodiment.

FIG. 3 shows a relationship between diffracted GNSS signals and measured responses in a GNSS receiver which receives the diffracted GNSS signals and provides correlation vectors as outputs used in one or more embodiments described herein.

FIG. 4 shows an example of how a building's surface (e.g., one or more windows on the outside surface of the building) can produce a diffraction pattern that includes a plurality of diffracted signals that can be received by a GNSS receiver (which in turn can produce a set of correlations vectors that implicitly represent the diffraction pattern).

FIG. 5 shows an example of an embodiment in which the correlation vectors can be used to calibrate the distance between the GNSS receiver's antenna and the reflecting surface of a building.

FIG. 6 shows an example of an embodiment in which the correlation vectors can be used to estimate the slope of a building's surface.

FIG. 7 shows an example of an embodiment in which an initial, uncorrected ray tracing model of an urban canyon (or other environment) is corrected using an observed set of one or more correlation vectors that were generated by a GNSS receiver according to one of the embodiments described herein.

FIG. 8 shows an example of a set of data processing systems and one or more GNSS receivers which can be used to implement the one or more embodiments described herein.

### DETAILED DESCRIPTION OF EMBODIMENTS

The various embodiments described herein can be used with ray tracing methods. Ray tracing, in the context of GNSS signals, computes a composite set of reflections relative to the true arrival time of a signal from a GNSS satellite at a known position in space and time accounting for as many known objects in the vicinity of the known position (e.g., at positions in an environment in an urban canyon).

A GNSS receiver can compute its location more accurately by matching (e.g., through pattern matching) the ray tracing from a set of visible satellites at a grid of positions around a precomputed approximate location with the measured set of reflections (measured by the GNSS receiver) to identify the closet grid point to the true location. A reflection may also be referred to as an echo.

The ray trace derived reflections are based on knowledge of the accurate location of each of the buildings, including all its surfaces or facades, and also the size (e.g., length, width, and height) of each building. A signal that is above a building will generate a diffraction at the building's roof line that is dependent on the surface, and exact height of the building.

Ground based imaging can be used to create the 3D building data needed to create the ray tracing models in an environment. Examples of ground based imaging include cars with sophisticated cameras mounted on the roof of each car, and each car is driven through streets that are lined with buildings (e.g., an urban canyon). However, ground based imaging has a height limitation. In other words, surveying techniques that use cameras mounted on a vehicle to capture images (which are then processed to extract geometry data such as a building's width, length and height) suffer from inaccurate height estimates. The estimate of building height is very dependent on building size (e.g., the taller the building, the more inaccurate the height estimate using ground based imaging).

The range of observable diffraction is difficult to predict and thus not included in ray tracing models. Similarly, the building surface will affect the diffraction in both amplitude and phase. A temporal change in the building shape will also affect the diffraction, such as open windows, signage, including nearby foliage.

Each reflection has a different amplitude and phase. The GNSS receiver observes the complex superposition of all GNSS signals received at the GNSS receiver. Signals that are far apart with respect to their correlation width in the time domain appear as discrete amplitude and retain the shape of their autocorrelation. Signals that are close together overlap and produce a distorted amplitude that have different correlation shapes than the autocorrelation shape. This will degrade the correlation or matching between predicted ray traces and measured reflections. The receiver's antenna will also impact the observed amplitude and phase of the measured reflections.

As described herein, a measurement (such as a set of correlation vectors collected at controlled or known locations in an urban canyon) can augment the predicted ray tracing model (for the urban canyon) to improve the correlation or matching with the GNSS receiver's observed (measured) set of reflections. The methods described herein can include the use of both the ray tracing and measured reflections and diffractions (e.g., from a GNSS receiver in the urban canyon that is included in a database derived from a corrected or improved ray tracing model) to improve the position accuracy when matching data from the ray tracing model and measured reflections and diffractions.

A method, in one embodiment, is presented that uses a data collection vehicle (e.g., an automobile) with a known location (e.g., through the use of a reference GNSS receiver and inertial navigation systems) and a GNSS receiver (e.g., a rover receiver) that can measure a set of reflections and diffractions to create a collected set of information such as a set of collected correlation vectors along a pathway, such as a pathway that is across a street in an urban canyon. The vehicle can include, as described further below, an inertial navigation system (e.g., a set of accelerometers and/or other known sensors in the art and/or other components to provide the inertial navigation system) that is initialized to provide true (known) position data and the reference GNSS receiver can provide GNSS system time and SV (satellite) ephemeris data (or other data that provides the position of each SV in space relative to GNSS system time) and the reference GNSS receiver that can share an antenna (e.g., through an antenna splitter) with the rover receiver. The vehicle can include, in one embodiment, a rack with one or more GNSS antennas. As described below, the one or more GNSS antennas can be used over a set of controlled or known positions to collect the correlation vectors at each of the controlled or known positions.

The GNSS receiver (e.g., the rover receiver on the vehicle) is provided, in one embodiment of a data collection portion of an embodiment, with its true location and the GNSS receiver clock bias is estimated with at least one direct satellite. In this way, the GNSS receiver can place a bank of correlators around the true phase of pseudorandom codephase, that is, the true arrival time, of any satellite, to enable the bank of correlators to observe of a range of reflections and diffractions for each satellite signal in the set of GNSS satellite (SVs) that are received by the GNSS receiver.

If the true range to the satellite is the geometric range r_{geo}, the satellite clock bias is bₛᵥ, the receiver clock bias is b_{rec}, and the other atmospheric measurement errors such as ionosphere and troposphere are in the Tₐₜₘₒₛ. The geometric range is norm of the vector from the receiver position to the satellite position. The atmospheric error can be provided by a server based system that is measuring in real time these delays. The true pseudorange in millisecond can be formed by converting the pseudorange from a distance in meters to a time in milliseconds as follows:

$$True pseudorange {pr}_{true} in milliseconds = ( {r}_{geo} + {b}_{sv} - {b}_{rec} + {T}_{atmos} ) / speed of light ( m / sec ) * 0.001 milliseconds / second$$

The receiver measures the part of the true pseudorange within the time range of the pseudorandom code (e.g., a primary PRN code), which for an L5 satellite is one millisecond composed of 10230 chips. The true codephase is the sub millisecond portion of the true pseudorange, formed by subtracting the integer millisecond portion of the total pseudorange in milliseconds.

$$True codephase ( milliseconds ) = {cph}_{true} = {pr}_{true} - integer ( {pr}_{true} )$$

For example, a typical true pseudorange in milliseconds is 75.432 milliseconds which means the integer millisecond is 75 and fractional millisecond is 0.432 milliseconds. For L5 with 10230 chips per millisecond, the true codephase is 10230 (chips/millisecond)*. 432 (milliseconds)=4,419.36 chips. The receiver can observe the signal by placing the local replica codephase (of the local replica of the primary PRN code) to this codephase. The correlation vector is generated by generating some local replicas of the primary PRN code before (lower codephase) the true codephase and some local replicas of the primary PRN after (higher codephase) the true codephase. Each time a correlation vector is collected, its GNSS system time and known location (e.g., from the reference GNSS receiver and/or inertial navigation system or by placing the GNSS receiver at a known location on the street) is recorded.

The correlation vector (“corrVec”) may be created, in one embodiment, by a bank of time domain correlators (which are known in the art), with each time domain correlator (in the bank) correlating the received GNSS primary PRN code against a local replica of the primary PRN (pseudorandom number) code at a particular codephase hypothesis. The output from each correlator in the bank of correlators provides a value that represents the result of the correlation operation performed by the particular correlator; since there are multiple correlators in the bank of correlators, there are multiple correlation outputs, at the end of each correlation operation, arranged as a vector of values (arranged, for example, from lowest codephase hypothesis to highest codephase hypothesis) and this vector of values is referred to as a correlation vector. Given that a goal in one embodiment is to capture diffracted GNSS signals (along with capturing a LOS signal), it may be desirable to have a large number of correlators in the bank (e.g., at least 20 or more correlators in the bank) to provide a wide range of possible codephase hypotheses. In an alternative embodiment, the GNSS receiver can use frequency domain correlation instead of time domain correlators; U.S. Pat. No. 11,686,855 describes examples of such frequency domain correlation methods and systems.

Predicting the true codephase in one embodiment requires the true receiver and satellites positions to form the geometric range, the predicted satellite clock bias, the predicted receiver clock bias, and the atmospheric estimates of ionosphere and troposphere.

The true position can be estimated in real time with a survey grade GNSS receiver (e.g., a Novatel GNSS receiver) that includes an inertial navigation system (e.g., with accelerometers, gyroscopes, etc.) so that the survey grade GNSS receiver can be initialized outside of the urban canyon (or other environment) by propagating an accurate position using acceleration and turning with inertial sensors, accelerometers, and gyroscopes, that can measure the vehicle's motion. The test or rover GNSS receiver and the survey grade GNSS receiver can share the same GNSS antenna that is mounted on the vehicle as described further below. US patent publication No. US 2021/0325548 describes an example of such a vehicle with both GNSS receivers and an inertial navigation system, and this patent publication No. US 2021/0325548 is incorporated herein by reference.

The predicted receiver clock is formed by acquiring and tracking at least one line of sight (LOS) satellite. By tracking the satellite and decoding its time stamp at transmission in the navigation data stream, the receiver can resolve the receiver time at reception to a resolution of 1 millisecond by propagating the received time stamp with an accurate integer millisecond pseudorange where the receiver clock bias is zero.

$${b}_{rec} = codephase - fraction of ( {r}_{geo} + {b}_{sw} + {T}_{atmos} ) / speed of light * 0.001$$

The geometric range and satellite clock are computed at the receiver time in one embodiment. The equation is re-arranged to solve the remaining fractional millisecond portion of the receiver time: the receiver clock bias

$$Time receiver ( milliseconds ) = time sastellite ( milliseconds ) + true pseudorange ( milliseconds )$$

Now, the receiver generates replicas of the satellite's pseudorandom code (e.g., primary PRN code) with a time range around the true codephase and correlates with the incoming signal. In general, the time range around the true codephase should be enough to capture the earlier diffractions and also the later reflections. This time range can be enlarged by increasing the number of correlators in the bank of correlators as described above.

If the signal is a direct LOS signal, a correlation peak will appear at the true codephase. The width of the correlation peaks is plus or minus one chip of the pseudorandom code, which for L5 is 29.3 meters that is equivalent to 1/10230 milliseconds, assuming propagation at the speed of light for a chipping frequency of 10.23 Mhz on a carrier frequency of 1176.45 MHz.

The range earlier is needed to capture diffraction, which is similar to the distance of the antenna to the point on the surface directly below the roof top edge from where the diffraction emanates. If the road is wide, such as 50 m, then the receiver must produce replicas at least this much time earlier. If the adjacent buildings, such as 200 m away, can produce reflections, then the receiver must produce local replicas at least as far away as the buildings.

The local replicas can be spaced according to the sampling rate at which replicas are formed. For replicas that are typically chose as ½ chip spacing, and with a sample rate equal to twice the chipping rate of the pseudorandom code, it is possible to interpolate between each replica to produce correlation estimates at finer precision than the local replica spacing.

In one embodiment, the number of local replicas used during correlation operations is 20 with ½ chip spacing and this produces a range of 20*0.5*29.3m/chip=293 meters. In one embodiment, the true codephase, which is sometimes referred to as the punctual codephase, is placed at tap 5 (the fifth correlator in the bank of correlators) so that there are 4 taps earlier, providing a range of 5*0.5*29.3=73.25 m before the true codephase and 293-75.25=219.75 meters after the true codephase. In case the receiver generates correlation vectors in batches of 20 taps, it is possible to place another bank of 20 later correlators to provide a later range of 220+293=513 m later. With two banks of correlators, it is also possible to produce a larger earlier range when there is a much larger space between the building and antenna.

With such a correlation vector, the receiver can observe the super-position of all reflections of the satellites signals off the buildings that arrive at the antenna. The super-position adds together the amplitude and phase of each reflection into the complex correlation vector. The building surface and building roof top edge produce a set of diffractions which can also be called a diffraction pattern. For each possible user receiver, a different clock bias and different small error associated with each predicted codephase, the observed phase for each reflection or diffraction will have a different common mode offset and will appear at a slightly different delay with respect to the replica codephase at each tap of the correlation vector. Thus, the magnitude, which is the square root of the sum of squares of the complex correlators (in-phase and quadrate components of the generated replica codes) is computed at each replica phase. In this way, the GNSS receiver uses a scalar value which is magnitude or power of the observed super-position at each tap of the bank of correlators. In this way, the correlation vector from a test instrument enables the observation of what a customer's GNSS receiver would observe at the same location when the satellite is in the same location in space.

The ray tracing data can be adjusted, as described further below, based on data from the measured correlation vectors. The knife edge diffraction from a building can produce a wide swath of diffractions. The outputs in the correlation vector can be interpolated to produce the observed pattern that can be parameterized as either a single ray with an amplitude and delay relative to the true codephase, or a set of rays in case the pattern is wider than ½ chip.

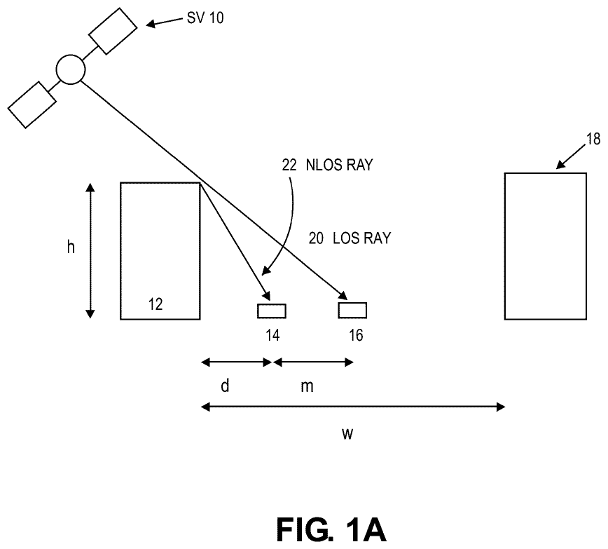

FIG. 1A shows a GNSS satellite (SV) 10, a building 12 and a building 18. The buildings 12 and 18 may be in an urban canyon with streets around the buildings. The buildings 12 and 18 are separated by a street that has a width of w which may accommodate multiple traffic lanes for vehicles. The building 12 has a height of h. The width of the street may be referred to as the across pathway direction; the across pathway direction can be perpendicular to the front façades of buildings 12 and 18. The roof edge of building 12 tangentially intersects the line of sight (LOS) ray 20 from the GNSS SV 10, and that intersection produces a knife edge diffraction shown as NLOS ray 22. The LOS signal ray 20 diffracts to produce diffractions that are earlier than the LOS signal and are bent down at an angle relative to the LOS ray 20. The FIG. 1A shows one diffracted ray, but in real life, there will be multiple rays, each with its own angle, amplitude, phase, and distance from where the LOS ray is incident on the surface of the street, here shown as position 16 (which may be referred to as an LOS point). The NLOS ray is incident on the surface of the street at position 14. The delay between the LOS ray 20 and the NLOS ray 22 is represented with the distance “m”. This distance m is the separation between positions 14 and 16 and represents an advance or negative delay (of the diffracted ray) with respect to the true codephase at the LOS ray 20. Position 14 has a distance of d from the front facade of building 12. The positions 14 and 16 can be one of the controlled locations used during collection of the correlation vectors as described herein.

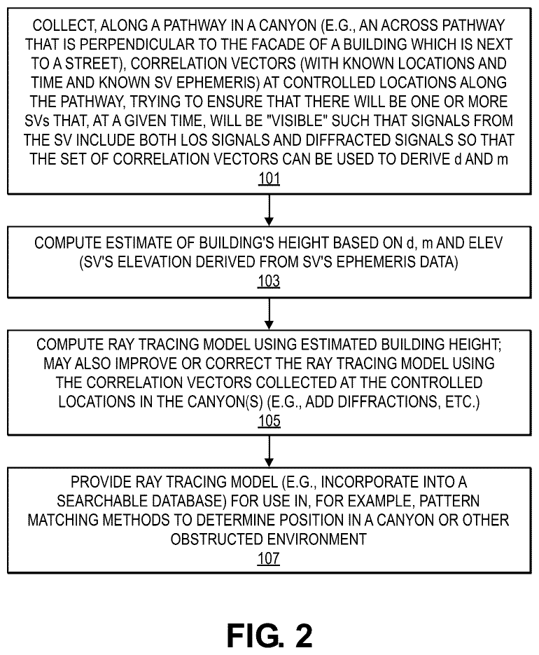

FIG. 3 shows a knife edge diffraction with 4 diffracted rays that have an increasing arrival time relative to the first ray on the left. The next two lines in FIG. 3 (going from top to bottom) show the complex components of the 4 diffracted rays. The different phase at each ray produces a different value in the in-phase part, the cosine component, and the quadrature part (the sine component). This complex representation is observable in the in-phase and quadrature correlators. The next line in FIG. 3 shows the received amplitude of each diffracted ray which is NOT observable as the observable portion is the magnitude of the in-phase and quadrature components. The addition happens in the complex domain.

The ray tracing methods will have difficulty predicting the number of diffractions and their respective in-phase and quadrature components. This is difficult for a number of reasons: firstly, the building height is not known precisely and this impacts the angle at which the signal is incident on the building, secondly the surface of the rooftop has a reflection coefficient that is related to the building material (such as metal, tile, shingle) and also shape (sharp, rounded, complex features or geometry).

The measured correlation vector samples the super-position magnitude. By interpolating, in one embodiment, between the adjacent codephases of the local replicas used in the correlations in the bank of correlators, the exact shape of the super-position magnitude can be observed. In one embodiment, the ray tracing model which may have many candidate rays is replaced or modified with the observed magnitude and delay from the true predicted codephase: the magnitude is the observed interpolated peak, and the delay is the phase: advanced, or negative for peaks earlier than the true codephase and delayed, or positive for the peaks later than the true codephase.

The same process can be used for ray tracing candidates that are a reflection off the side of the building. There can also be multiple bounces: that is, each satellite produces multiple paths to the same antenna location off of different or multiple buildings. In a ray tracing model with, each reflection is a single ray. But in the case of complex building surfaces, there can also be more reflections which are very difficult to predict without an advanced model of the building surface and material. Just as with the knife edge diffraction, the building reflections are observed as a super-position of the multiple reflections. The observed correlation vector produces an observation of the super-position of the actual reflections.

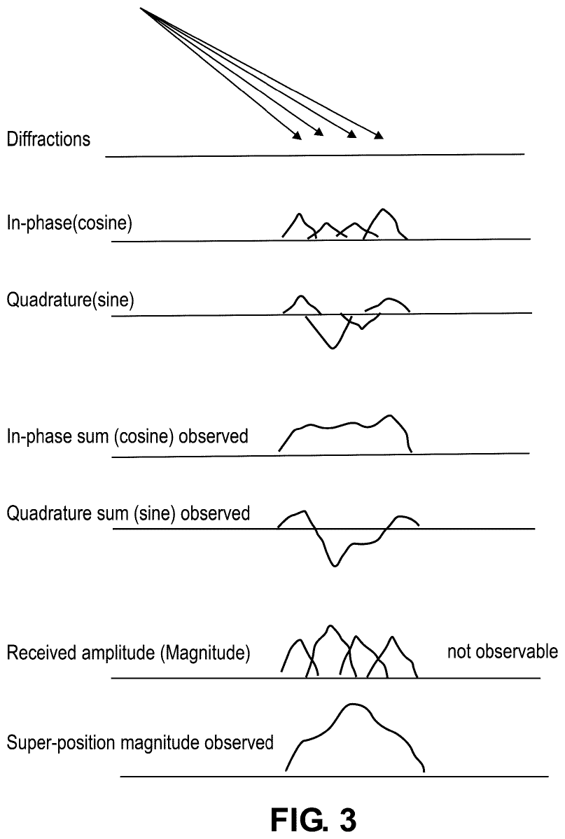

### Building Surface Observation (see FIG. 4)

In another embodiment the correlation vector is used to estimate some building parameters such as its height or its surface. The surface of a building often includes variations in geometry (e.g., balconies, eaves, soffits, etc.) and variations in the type of construction materials (e.g., steel, concrete, glass, etc.). The height impacts the observed delay (or advance). The surface impacts the number of adjacent delays which impacts the width of the observed super-position magnitude. The observed correlation vector can be used, as described herein, with various ray tracing models to estimate parameters related to the building height or surface.

As shown in FIG. 4, the rays from the single GNSS satellite are in parallel because of their large distance from the buildings (building 1 and building 2). Notice that the LOS signal is blocked (by building 1 in FIG. 4) and the NLOS signal arriving at the antenna has multiple rays. One or more windows on building 2 produce diffraction which produces the multiple rays arriving at the antenna. Just as in the diffraction case above (in FIG. 3), the super-position of all rays (from the diffraction produced by the one or more windows in this example in FIG. 4) is the complex addition of the amplitude and phase of each ray. Thus, the observed/measured correlation vector will measure the super-position allowing characterization as a single ray with a delay of the peak of the super-position, or a series of rays in case the super-position is larger than the autocorrelation function which is +/−1 chip, which is +/−29.3m in the L5 case.

### Building Height

A building's height in one embodiment can be estimated using the following method which uses the collected data in correlation vectors that were measured while in an urban canyon. These correlation vectors should include data from both diffracted signals and LOS signals as described further below.

FIG. 1B shows an example of the geometry of the urban canyon shown in FIG. 1A. The height of the building 12 (in FIG. 1A) is shown as the height h of the right triangle 35 (in FIG. 1B), and this right triangle 35 includes (within the right triangle 35) a smaller right triangle and an obtuse triangle. The right triangle 35 has sides having lengths of a, h and d+m. The smaller right triangle has sides having lengths of h, d, and b (for its hypothenuse). The obtuse triangle has sides of lengths m, b, and a and has angles shown as elev and α. The smaller right triangle has angles of 90, 90-β, and β. Point 37 on the right side of right triangle 35 corresponds to position 16 in FIG. 1A, and the point 39 corresponds to position 14 in FIG. 1A. The distance between point 37 and point 39 is m (as in FIG. 1A), and the distance from point 39 to the front facade of building 12 is d (as in FIG. 1A). When the building's height is being estimated by this method, h is the main unknown. The total distance from the building to the antenna (d₂+m) is known when a set of one or more correlation vectors are collected (e.g., from a survey grade GNSS receiver that also includes an inertial navigation system). Also, the elevation angle (elev) to the building rooftop edge is the same as the elevation to the satellite that transmits the LOS signal to point 37 (corresponding to position 16 in FIG. 1A). The advance of the diffraction from the LOS point 37 is m which is measured when the correlation vector is placed at the LOS codephase associated with the true codephase. For example, the value for m can be determined from the number of chips (both integer and fractional values) in the correlation vector separating the detected LOS point 37 and the detected diffraction ray (at point 39). This number of chips can be converted (using the speed of light) to the distance m. In other words, a distance from a peak from the diffraction ray or rays and the peak for the LOS signal (detected at LOS point 37) in the correlation vector can determine m. The following equations represent a method to solve for h based on this geometry and the data from the collected correlation vectors (from which d and m are determined).

The sum of all angles on the right triangle 35 is: α+β+90+elev=180. Solving for β:

$$β = 90 - ( α - elev )$$

Using the Pythagorean theorem for right triangle 35 and the smaller right triangle:

$${h}^{2} = {a}^{2} - {( d + m )}^{2} \qquad ( Equation 4 )$$

$${h}^{2} = {b}^{2} - {d}^{2} \qquad ( Equation 5 )$$

Applying the law of cosines to the three triangles above (as shown in FIG. 1B):

$$\begin{matrix}{h}^{2} = {b}^{2} + {d}^{2} - 2 {b}^{*} {d}^{*} cos ( 90 - β ) \\ {b}^{2} = {a}^{2} + {m}^{2} - 2 {a}^{*} {m}^{*} cos ( elev ) \\ {m}^{2} = {a}^{2} + {b}^{2} - 2 {a}^{*} {b}^{*} cos ( α )\end{matrix}$$

Replacing β with its relationship to a and elev:

$${h}^{2} = {b}^{2} + {d}^{2} - 2 b * d * cos ( α + elev ) \qquad ( Equation 1 )$$

$${b}^{2} = {a}^{2} + {m}^{2} - 2 a * m * cos ( elev ) \qquad ( Equation 2 )$$

$${m}^{2} = {a}^{2} + {b}^{2} - 2 a * b * cos ( α ) \qquad ( Equation 3 )$$

This makes 5 unique equations with 4 unknowns: h, a, b, and a. The known values are d, m, and elev. These non-linear equations can be solved in the following manner. The angle elev is the elevation to the SV that transmitted the LOS ray received at point 37 (or determined from interpolations using locations that surround point 37 as described further below); this elevation can be derived from the SV's ephemeris data at the GNSS system time the LOS ray was transmitted. As described herein, a reference GNSS receiver and inertial navigation system can provide a true location and GNSS system time during the surveying process along the across pathway that includes the lengths d and m. Thus, the reference GNSS receiver and inertial navigation system can provide the value of the sum of d+m. The one or more correlation vectors can establish the location for and value of m.

Combining the two equations for h² (Equations 4 and 5) produces:

$${a}^{2} - {( d + m )}^{2} = {b}^{2} - {d}^{2}$$

### Solving for b²:

$${b}^{2} = {a}^{2} - {( d + m )}^{2} + {d}^{2} = {a}^{2} - 2 d * m - {m}^{2} \qquad ( Equation 6 )$$

Substituting b² into the second law of cosines equation (Equation 2):

$${a}^{2} - 2 d * m - {m}^{2} = {a}^{2} + {m}^{2} - 2 a * m * cos ( elev )$$

Thus, solving for a:

$$An estimate of a is : {a}^{∧} = ( d * m + {m}^{2} ) / m * cos ( elev )$$

Plugging this solution of a into Equation 6:

$$So {b}^{2} = {( ( d * m + {m}^{2} ) / m * cos ( elev ) )}^{2} - 2 d * m - {m}^{2}$$

And an estimate of b is:

$${b}^{∧} = {[ {( ( d * m + {m}^{2} ) / m * cos ( elev ) )}^{2} - 2 d * m - {m}^{2} ]}^{1 / 2} .$$

Since elevation has to be positive, and b has to be positive, there is only one value for b which is positive as elev, d, and m are all positive.
To solve for the angle α we use Equation 3:

$${m}^{2} = {a}^{2} + {b}^{2} - 2 a * b * cos ( α )$$

$${α}^{∧} = - {cos}^{- 1} [ ( {m}^{2} - {a}^{∧ 2} - {b}^{∧ 2} ) / 2 {a}^{∧} * {b}^{∧} )$$

It will be appreciated that cos-1 is the arccosine function (also written as “arccos”).
To solve for h, we plug in the estimated values for a,b, a, and elev into Equation 1. Since a negative building height is not defined, based on the estimates for b∧, b^{∧2}, α∧ the building height estimate is:

$${h}^{∧} = {[ ( {b}^{∧ 2} + {d}^{2} - 2 {b}^{∧} * d * cos ( {α}^{∧} + elev ) ]}^{1 / 2}$$

An approximate building height estimate can help reject outliers. Also, the diffraction case requires a value of m that is more than the multipath envelope for cases of near multipath such as from ground bounces or close objects. For L5, the typical multipath error is bounded at about ¼ chip, a value arrived at empirically by trying all the possible phases of a short delay (less than 1 chip) and magnitude down 3 dB. Thus, the knife edge case is only identified when m is larger than about 7 meters in the L5 multipath case and when the building height aggress with an approximate height based on a camera that can assert that the building height is higher than what it can estimate as the building rooftop does not appear to be valid based on the camera image: likely because a large enough horizontal edge cannot be identified with enough confidence.

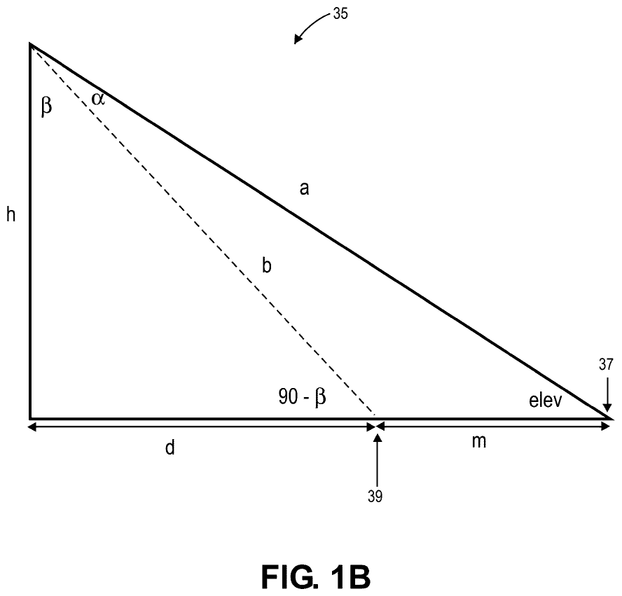

FIG. 2 shows an example of a method that can use the height computation specified above to determine height estimates from survey data and then use the estimated heights to improve a ray tracing model. The survey data can be collected in operation 101 in FIG. 2 using a vehicle or a pedestrian who uses a cart to collect the data. In a typical survey or data collection procedure, a GNSS receiver and a survey grade GNSS receiver are used to collect the correlation vectors which are collected at known locations (because of the inertial navigation system and the survey grade GNSS receiver which supplies GNSS system time and the known location of the two GNSS receivers during the data collection phase). Each collected set of correlation vectors can be stamped or otherwise associated with a time (e.g., GNSS system time) and known location and known SV ephemeris data at the time (so that the correlation vectors can be processed later after the data collection procedure). It may be desirable to collect a series of correlation vectors over a set of controlled locations along an across pathway of the street next to the building that will produce the diffractions described above (e.g., as shown in FIGS. 1A and 1B). For example, it may be desirable to position the receivers at each of the set of controlled locations which are spaced apart (e.g., 5 feet apart) along the across pathway (e.g., road) which is typically perpendicular to the front facade of the building that produces the diffractions. For example, if the pathway is 100 feet wide, there may be 19 controlled locations along a line perpendicular to the front facade, with the 19 locations spaced apart by 5 feet. One way of achieving this collection can involve walking (with the equipment) across the street towards the building (e.g., in a path that is perpendicular to the front facade of the building), from one side of the street to the other side of the street, stopping at each controlled location along the across pathway. Normally, the flow of vehicle traffic is perpendicular to this across pathway. It is desirable that at least one of the controlled locations ensures that there will be one or more SVs that, at a given time during the data collection, will be “visible” such that signals from the SV include LOS signals (at or near point 37 in FIG. 1B) and diffracted signals (at or near point 39 in FIG. 1B). This method can thus ensure the set of correlation vectors and known data (e.g., from the survey grade receiver) can be used to derive m and d (e.g., as shown in FIG. 1B). Once the data is collected for a building or set of buildings, a data processing system can compute, in operation 103 in FIG. 2, an estimate of a building's height based on d, m and elev as described above. The one or more estimated building heights can then be used in operation 105 to compute a ray tracing model using the one or more estimated building heights. In addition, as described further below, the collected correlation vectors can be used to improve the ray tracing model (e.g., by adding data about diffractions and correcting other data based upon the measured correlation vectors). The improved ray tracking model can then be used in operation 107 to provide estimated positions using, for example, pattern matching methods to determine the estimated positions; examples of pattern matching methods are described in US patent publication No. US 2021/0325548.

If a vehicle is used to collect the correlation vectors and other data at the controlled locations in operation 101, the vehicle may use a roof mounted rack to allows a shared GNSS antenna to move to different positions across the rack to provide the data collections at each of the different positions on the roof. The vehicle can drive in each of the lanes on the street to collect a full set of data at different controlled locations along the across pathway direction. An alternative to a shared, moving antenna is a rack on the roof that supports several GNSS antennas, and a GNSS antenna switch and splitter is used to switch the antenna inputs (to the GNSS receiver and the survey grade GNSS receiver) between the several GNSS antennas. It is desirable to collect the data at the different controlled locations over a short period of time (e.g., less than 30 seconds).

The different controlled locations along the across pathway distance can allow the data collection procedure (and subsequent data processing) to detect the LOS point (e.g., point 37 in FIG. 1B) which, in one embodiment, is the closest location to the building at which an LOS signal is received (e.g., above a threshold) and the diffractions (produced by the building) are also detected at that LOS point (e.g., at point 37). In the following example, it is assumed that the sequence of controlled locations begins on the opposite side of the street and ends close to the building. For example, a method can look for a transition in the set of correlation vectors from one controlled location (“first controlled location”) to the next controlled location (“second controlled location” which is closer to the building than the first controlled location); that transition can be the disappearance (below a threshold) of the LOS signal (in the correlation vector from the second controlled location) which indicates that the receivers have moved from one side of LOS point 37 to the other side of LOS point 37. The method can interpolate or estimate the point 37 (e.g., halfway between the first and second controlled locations). The distance m can be determined from the delay (measured in the correlation vectors) between the LOS point in the correlation vector and the detected diffractions in the correlation vector.

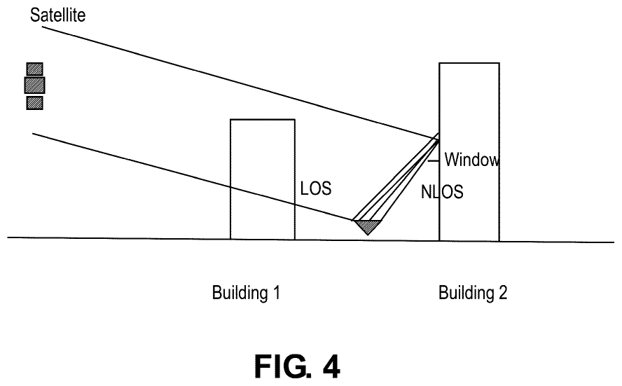

### Building Distance Calibration (See FIG. 5)

In another case, the building footing is not known precisely and the building side is at 90 degrees from the surface as shown in FIG. 5. The correlation vector can be used to improve the estimate of the distance d between the antenna of the GNSS receiver (which collects the correlation vectors) and the surface/footing of the building shown in FIG. 5.

The distance from the antenna d can be solved using d=m*cos (90-elev). Notice that reception of the LOS signal is optional. An approximate estimate for d can be used to identify the echo after the LOS signal location. In this case, the correlation vector measurement is used to update the building data to improve the ray tracing estimate.

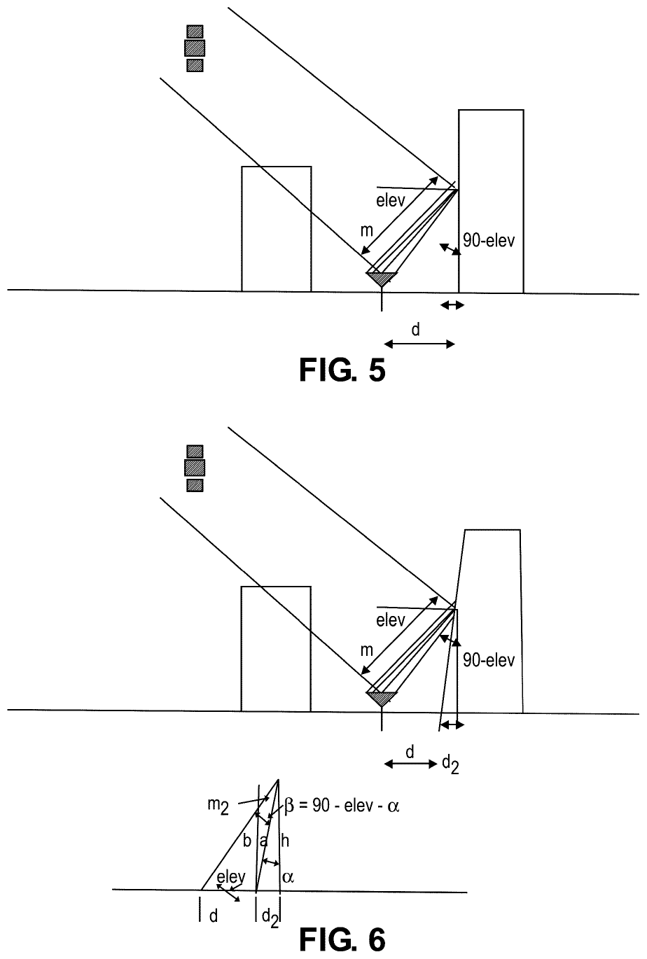

### Building Façade Calibration (See FIG. 6)

In another case, the building footing is known precisely but the building has a sloping façade as shown in FIG. 6. The correlation vectors from a GNSS receiver as described herein can be used to improve the estimate of the slope of the facade of the building as shown in FIG. 6.

The additional distance of where the intersection point hits the surface at height h is d₂. The angle of the façade is a. The angle of incidence on the building is b=90-elev+α which is also the angle of refraction. The known parameters are d, m, and elev.

For the right triangles using Pythagorean theorem:

$$tan ( elev ) = h / ( d + {d}_{2} )$$

$$h = tan ( elev ) * ( d + {d}_{2} )$$

$${m}^{2} = {( d + {d}_{2} )}^{2} + {h}^{2}$$

$$\begin{matrix}{m}^{2} = {( d + {d}_{2} )}^{2} + {( tan ( elev ) * ( d + {d}_{2} ) )}^{2} \\ = {( d + {d}_{2} )}^{2} * [ 1 + tan ( elev ) ]\end{matrix}$$

$${( d + {d}_{2} )}^{2} = {m}^{2} / [ 1 + tan ( elev ) ]$$

The estimate of d₂ is:

$${d}_{2}^{∧} = {( {m}^{2} / [ 1 + tan ( elev ) ] )}^{1 / 2} - d$$

So d₂ is known as m, elev, and d are known. The estimate can be rejected if the estimate is negative.
The estimate of the building height at the reflection is:

$${h}^{∧} = tan ( elev ) * ( d + {d}_{2}^{∧} )$$

The building slant a is:

$$Tan ( α ) = h / {d}_{2}$$

The estimate is:

$${α}^{∧} = Tan - 1 ( {h}^{∧} / {d}_{2}^{∧} )$$

### Extrapolating Test Data Toward Customer Usage

The ray tracing and measured echoes can also be combined to predict what a receiver will observe at other locations. That is, during a controlled observation phase, where antenna location is known, there may be a small number of tested locations. This makes sense as the number of locations is determined by the number of test vehicles, which would likely be small. These can be referred to as the control locations. When customers, or random rovers, are consumers of the ray tracing assistance, their true location will be at random locations near the control locations and the purpose of the ray tracing assistance is to improve the estimate of these random locations based on the observations from nearby control locations. The approximate rover locations will produce a set of candidate locations as a set of grid points around the approximate location. In one embodiment, the distance of each grid point from the control points can be computed, and the diffraction delays can be modified with a geometric scaling at each grid point related to the difference between the distance to the reflection sources, that is, the buildings.

How to Scale from Controlled to Non-Structured Data

The collected correlation vectors can be used to modify the ray tracing estimates when the true location is available. This requires a complementary GNSS and inertial, or camera based system to estimate the test receiver's location and clock bias. This is the controlled case. A non-controlled case arises in the context of crowd sourcing when the complementary truth system is not available. Here the rover receivers (e.g., the GNSS receivers used by the “crowd”) will produce correlation vectors for each satellite, but the true location is not known in real time: the position will have error as it may use some of the NLOS measurements in the position fix. Such data is still valuable in case the rovers are static for some brief periods of say 30 seconds. This is possible when the GNSS data was collected at the same time with inertial data, such as accelerometer and gyroscope data from a MEMs device that is integrated on a circuit board along with the GNSS circuitry, or with WiFi or cellular data that allows accurate ranging from surveyed transmitters. In this case, the rover position can be estimated after the fact by smoothing all available position data obtained during the observation period to produce a more accurate location that what was computed in real time with the data available independently each one second for example. Once an improved location is available, then the rover correlation vectors can be labeled with a reasonably accurate codephase at each replica code. That is, the correlation vectors of nearby receivers can be combined.

### About Signal Strength

The controlled receivers should employ an antenna system and RF processing solution with the smallest amount of loss to produce the strongest possible signals, that is, with the strongest achievable signal to noise ratio (SNR). This will allow even weak diffractions to be observable. The rover receivers, however, will likely use lower cost antenna and RF systems that have more loss and result in weaker signals, smaller SNRs. Thus, they may not be able to observe the weaker diffractions. However, by crowd sourcing the correlation vectors, the correlation vectors can be combined at nearby locations to improve the SNR so that more diffraction is observable and aid in the improvement of the ray tracing model to match the observed super-position.

The alignment of crowd sourced correlation vectors can be done in the fractional geometric range domain: that is, the measured correlation vectors with their associated codephases include an additive receiver clock bias dependency. Given the improved location, the receiver clock bias can be estimated and removed from the codephase at each replica tap.

The reference, or punctual, tap for each correlation vector is generated based on the estimated receiver location and clock bias. When there is position and clock bias error, the codephase label will be in error by the sum of the clock bias error and the dot product of the position error with the direction cosines.

$$Codephase = fraction \{ ( {r}_{geo} + {b}_{sv} - {b}_{rec} + {T}_{atmos} ) / speed of light ( m / sec ) * 0.001 milliseconds \}$$

$$Codephase error = U * δ {p}_{rec} + δ {b}_{rec} where$$

$$U is the direction cosine vector , {u}_{x} , {u}_{y} , {u}_{z}$$

$$δ {p}_{rec} = dx , dy , dz , the x , y , z position error at the time when the corrVec was generated ,$$

$$δ {b}_{rec} = error in the receiver clock estimate when the corrVec was generated .$$

In a crowd sourced post processing step, the reference codephase for each tap (e.g., position within a correlation vector) is corrected by the post processed position and clock estimate. Thus, the labeled codephase for each replica corrVec tap is corrected. Note that the replica codephase taps can be at fixed offsets from the punctual codephase in units of ½ chip generally. Thus, the codephase will have fractional chips units that are not multiples of an integer number of ½ chips. To solve this, the corrVecs can then be interpolated to produce amplitude estimates at fixed true codephases: such as every .25 chips.

After correcting the reference codephase, the corrVecs at common codephase and nearby locations can be summed non-coherently. The locations can be defined by a grid so that all replicas with a location within say 5 meters of the grid can be summed. This threshold of 5 meters is related to the size of the autocorrelation function which is +/−29.3 meters for L5.

Note that because of the random error in real time, the corrVecs will not be covering the same codephase range. However, this interpolation process can return the corrVecs to a common reference needed for summation. This will improve the SNR by 1.5 db for each doubling of the number of averaged corrVecs. This process is similar to non-coherent integration in the GNSS signal acquisition process.

Augmenting Ray Tracing Accuracy of Phase and Amplitude with the Correlation Vectors

A ray tracing model will produce a set of reflections from many possible candidate reflections sources that will arrive at a known location at a known time based on the positions of GNSS SVs at the known time. The challenge for the ray tracing designer is to include as many signals as possible but also to include the signal characteristics of what an actual receiver would observe at each point (e.g., a set of points over a grid of x, y coordinates an environment such as one or more streets in an urban canyon).

The factors in the selection of signals are 1) the amplitude and 2) the delay and 3) the number of rays based on signal that is being modeled and 4) how close or overlapping signals are observed and 5) unpredicted reflections. These factors are:
1) Amplitude: here the ray tracing wants to include rays that are strong enough to be observed. Many reflections from multiple bounces will eventually become too weak and are therefore removed. Since pattern matching usually has a normalization step, what is desired is the relative amplitude between the reflections.
2) Delay: here the ray tracing wants the relative delay with respect to the LOS signals. The actual delay impacted on the building location accuracy and also on the model of the building surface. Most ray tracing needs to choose a reflectivity coefficient. However, the building surface is difficult to predict, especially for tall buildings that are above the ground based cameras used to accumulate Street-View like information.
3) Number of rays: here the ray tracing wants to predict how many reflections will be produced by a building surface. A glass surface can be modelled as a single reflection, but a surface with complex windows or surfaces may produce many reflections.
4) Overlapping signals: here there may be multiple reflections that arrive at a similar time within the autocorrelation length of the signal of interest. For GNSS L5, the autocorrelation function is triangular with a base of +/−1 chip where the chip is a CDMA chipping sequence bit, which is +/−29.3m. Thus, reflections withing a chip will overlap and produce a delay based on the complex super-position of the reflections.
5) Unpredicted signals: Local objects not in the building data base will produce reflections in the corrVec that are not predicted in the ray tracing models.

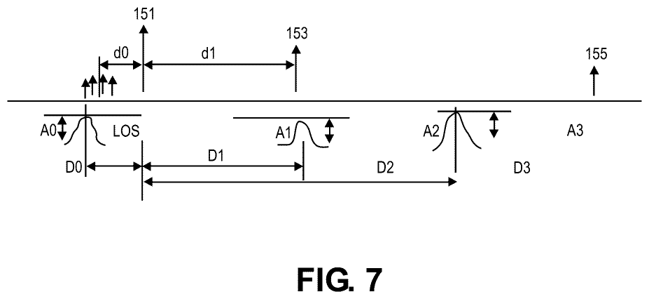

The set of one or more correlation vectors observes all the factors implicitly, and the observed factors can be used to correct or improve a ray tracing estimate derived from estimates of building parameters. An example of this improvement is shown in FIG. 7.

Imagine a ray tracing estimate (shown in FIG. 7) that has three rays (shown by the three up direction arrows 151, 153, and 155 in FIG. 7) before any corrections or additions from data from the collected set of one or more correlation vectors.

A0, shown in FIG. 7, represents a diffraction. It represents a case where the building height is in error so that the predicted refractions are shifted. The corrVec will observe the super position of all true rays whereas the ray tracing will have difficulty in case the roof top surface shape and reflectivity coefficient are unknown. The corrVec will produce an amplitude A0 that is a complex superposition. If the refractions are within a chip, the peak amplitude will be dependent on relative phases of each constituent. In this case the A0 amplitude is similar to the LOS. The corrVec provides the negative delay DO and ray tracing correction d0=d0−D0 (shown in FIG. 7).

LOS is the line of sight. The LOS signal is blocked in this case shown in FIG. 7.

A1, shown in FIG. 7, represents a single reflection that has an error by a small amount due to a building location error. The corrVec provides the delay estimate D1 and a correction, d1 shown in FIG. 7, to the ray tracing model can be computed as: d1=d1−D1. The corrVec provides an estimate of amplitude A1.

A2, shown in FIG. 7, represents a case where the ray tracing does not have an estimate but there is an unknown object, producing a reflection. The ray tracing could be augmented at least temporarily with this signal. It provides the delay estimate D2 and an amplitude A2.

A3, shown in FIG. 7, represents a case where the ray tracing predicts a signal but it is not present in the corrVec. The ray tracing model would be modified by setting the amplitude of A3 to zero in the improved and corrected ray tracing model.

### Enumerated Embodiments

The following enumerated embodiments below represent potential claims in one or more patent applications.

1—Combining ray tracing predictions from one or more ray tracing methods with actual observations with a GNSS receiver in an environment, based on one or more correlation vectors at known locations in the environment, to provide more accurate ray tracing predictions for the models which include one or more of modified amplitude or delay values of the ray tracing methods to match the actual observations.
2—Using crowd sourced corrVecs based on summing up amplitude estimates at a common codephase that are corrected based on a post processed position and clock bias estimate for each data source.
3—Using the observed corrVec amplitude response to correct a building height model.
4—Using the observed corrVec amplitude response to correct a building surface model.
5—Using the observed corrVec amplitude response to correct a building distance from an estimated location.
6—Using the observed corrVec amplitude response to detect a slanted building surface.

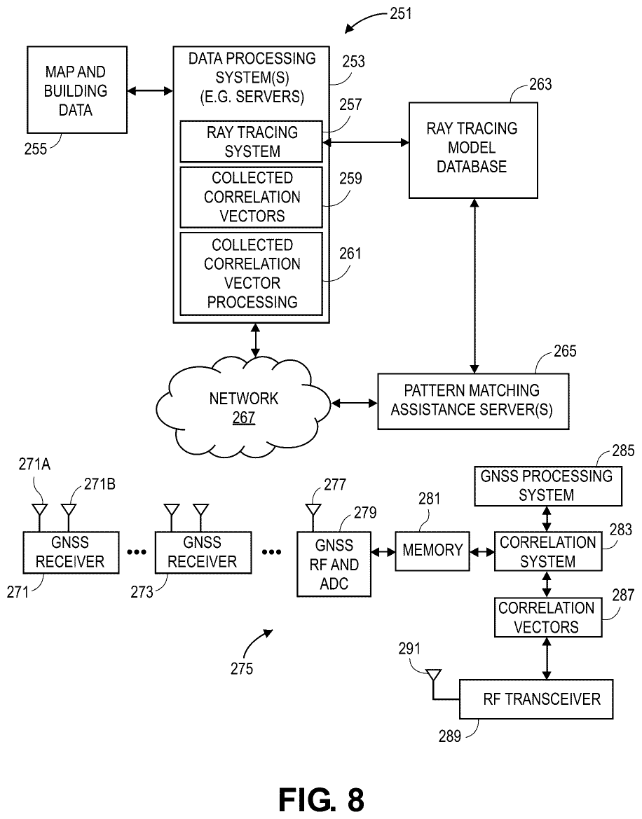

FIG. 8 shows an example of a system 251 that can include one or more embodiments described herein. The system can include one or more server data processing systems 253 that receive correlation vectors 259 from GNSS receivers within an environment (e.g., an urban canyon) and use these correlation vectors to improve or correct ray tracing models 263 according to the embodiments described herein. Further, the ray tracing models can then be used to create shadow matching assistance data, stored in a storage device, that can be used in pattern matching methods to determine positions of GNSS receivers in the environment after the shadow matching assistance data has been created. The GNSS receivers (e.g., GNSS receivers 271, or 273 or 275) in the environment can request use of the shadow matching assistance data (e.g., from pattern matching assistance server(s) 265) to improve position solutions based on a pattern matching method, such as a pattern matching method described in published patent application US 2021/0325548. The system 251 can perform the method shown in FIG. 2 in one embodiment. The one or more data processing systems 253 can be coupled to a source 255 of map data and building data that provides conventional location information and size information about buildings and this source 255 can be used with known ray tracing systems, such as ray tracing system 257 to create a ray tracing model database 263, which can contain the initial ray tracing model prior to improvements or corrections provided by the embodiments described herein through the use of collected correlation vectors 259. The one or more data processing systems 253 can be coupled, through network 267 (which can be one or more networks, including for example cellular telephone networks, WiFi networks, wired networks, the Internet, etc.) to a set of GNSS receivers that can be used to collect the correlation vectors in an environment (e.g., an urban or suburban canyon) as described herein (e.g., operation 101 in FIG. 2), and these correlation vectors (and associated data such as the location and GNSS system time of the collection of each correlation vector and SV ephemeris data at the time of the collection) can be uploaded (e.g., through network 267) into storage of the collected correlation vectors 259. GNSS receiver 275 shows an example of a GNSS receiver which can be used to collect the correlation vectors, and many such GNSS receivers (e.g., GNSS receivers 271 and 273) can be used to collect correlation vectors over a set of points or controlled (e.g., predetermined and known) locations in the environment. Once a sufficient set of collected correlation vectors for an environment have been received and stored in collected correlation vectors 259, the one or more data processing systems can use the collected correlation vector processing 261 (and the stored collection of correlation vectors 259) to perform one or more of the methods described herein (e.g., operations 103 and 105 in FIG. 2 and the operations described with FIG. 7) to correct and/or improve the initial ray tracing model in database 263. The corrected and/or improved ray tracing model (now stored in database 263) can be coupled to one or more pattern matching assistance servers 265 that can provide pattern matching assistance data for use in patterns matching operations (e.g., see published patent application US 2021/0325548), which can be performed at each GNSS receiver or in a server (such as the assistance servers 265). The pattern matching assistance servers 265 can be coupled to one or more GNSS receivers through network 267 to perform these pattern matching operations.

Each of the GNSS receivers 271, 273, and 275 can include at least one GNSS antenna (e.g., GNSS antennas 271A and 277) and at least one RF antenna (e.g., RF antennas 271B and 291). The GNSS antennas can receive GNSS signals from GNSS SVs, and the RF antennas can receive and transmit RF communications signals (e.g., cellular telephone or WiFi or other wireless communication signals), such as signals containing collected correlation vectors or signals requesting or receiving pattern matching assistance data or GNSS assistance data. GNSS receiver 275 shows a more detailed example of a GNSS receiver, which includes one or more GNSS antennas 277 coupled to a GNSS RF front end and analog to digital converter (ADC) 279. The GNSS signals are received through the one or more GNSS antennas 277, filtered by the RF front end and digitized by the ADC, and digitized representation (digital samples) of the received GNSS signals are stored in memory 281. A correlation system 283 correlates the digital samples to generate correlation vectors 287; the correlation system 283 can be a conventional time domain correlation system. The generated correlation vectors 287 can then be processed by a conventional GNSS processing system 285 to determine GNSS measurements such as pseudoranges to GNSS SVs, and the GNSS processing system 285 can also compute position solutions using the pseudoranges and SV ephemeris data as is known in the art. The position solutions can be corrected based on pattern matching methods (e.g., see published patent application US 2021/0325548). The generated correlation vectors 287 can also be transmitted, through RF transceiver 289 and RF antenna 291 through the network 267 to the one or more data processing systems 253 (e.g., for storage in collected correlation vectors 259). The one or more embodiments of a GNSS receiver described herein can be used in a system with other components that are coupled to the GNSS receiver. Examples of such systems include, for example, smartphones, smart watches, wearables (e.g., headmounted displays or fitness wearables), internet of things (IoT) devices, vehicles (e.g., an automobile), and other devices that can include a GNSS receiver to provide position information, etc.

The embodiments (e.g., one or more GNSS receivers) described herein can receive and process GNSS signals from GNSS SVs that are part of one or more GNSS constellations deployed or developed by one or more governments (such as the United States GPS (Global Positioning System) system, the European Galileo system, the Chinese Beidou system, the Japanese QZSS system, the Russian GLONASS system and other such governmental systems, including regional systems, now or in the future), and the embodiments described herein can also be used with other satellite systems (e.g., low earth orbiting [LEO] satellites or other SVs which may not be deployed by or developed by a government and may be privately owned) or pseudolite systems (e.g., terrestrial systems including cellular telephone towers and other ground based transmitters) that transmit navigation signals that include ranging codes (e.g., PRN codes) and/or other data that can be used to determine a position in a receiver based upon the transmitted signals that are received by the GNSS receiver. Thus, the term GNSS SV (or GNSS satellite) is intended to include all such satellites systems and pseudolite systems, now or in the future, and the term GNSS receiver is intended to include a receiver that can receive and acquire and process transmitted signals from a subset of or all of such satellite systems and pseudolite systems to determine a position of the GNSS receiver. Moreover, the term GNSS signals is intended to include such transmitted signals from a subset of or all of such satellite systems and pseudolite systems. In other words, a GNSS SV is any transmitter/source of signals, such as GNSS signals, that can be received by and used in a GNSS receiver to determine the receiver's position (e.g., latitude and longitude) from the received GNSS signals. Hence, for example, the embodiments described herein can be used with navigation systems based on low earth orbiting SVs or other SVs or ground based transmitters that transmit navigation signals that can be used by a GNSS receiver to determine its position.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A method to compute data for determining a position based on use of signals from one or more GNSS satellites, the method comprising:
collecting, in an environment, a set of one or more correlation vectors from received GNSS signals in the environment from one or more GNSS satellites (SVs), the collecting using data that provides a known location and time and ephemeris of the one or more GNSS SVs;
determining, from the collected set of one or more correlation vectors, a first set of data;
generating a ray tracing model based upon the first set of data and data about objects in a vicinity of the environment, the ray tracing model describing the expected behavior of received GNSS signals in the environment.

2. The method as in claim 1, wherein the environment is an urban canyon that includes one or more buildings that obstruct GNSS signals from GNSS SVs.

3. The method as in claim 1, wherein the first set of data includes corrections or additions to the ray tracing model.

4. The method as in claim 3, wherein the additions include one or more amplitudes and phase data for diffractions determined from the collected set of one or more correlation vectors.

5. The method as in claim 1, wherein the first set of data includes data estimating one or more heights of one or more buildings in the environment.

6. The method as in claim 1 wherein the first set of data includes amplitudes of values in the set of one or more correlation vectors.

7. The method as in claim 1, wherein the set of one or more correlation vectors are from a crowd sourced set of data from a plurality of GNSS receivers.

8. The method as in claim 1, wherein the collecting comprises: determining from a reference GNSS system a location and GNSS time and SV ephemeris data, and associating the determined location, GNSS time and ephemeris data with each of one or more controlled locations in the environment.

9. The method as in claim 1, wherein the first set of data includes an estimate of one or more heights of one or more buildings in the environment, the estimate of the one or more heights derived from one or more observed LOS signals and one or more observed diffraction signals in the set of one or more correlation vectors.

10. The method as in claim 9, wherein the first set of data is computed from a geometric relationship relative to a building in the environment that creates the one or more diffraction signals.

11. The method as in claim 10, wherein the ray tracing model is stored for use in pattern matching operations to compute one or more locations of GNSS receivers in the environment.

12. The method as in claim 1, wherein the determining comprises: determining a transition in an LOS signal from one controlled location to an adjacent controlled location to detect a knife edge diffraction effect from a roof edge of a building.

13. The method as in claim 1 wherein the first set of data is used to correct a building surface model for one or more buildings in the environment.

14. The method as in claim 1 wherein the first set of data is used to estimate a distance to a building in the environment.

15. The method as in claim 1, wherein the first set of data detects a slanted facade of a building in the environment.

16. A data processing system comprising:
a network interface to receive a set of one or more correlation vectors derived from received GNSS signals in an environment from one or more GNSS satellites (SVs), the set of one or more correlation vectors collected with data that provides a known location and time and ephemeris of the one or more GNSS SVs;
one or more processing systems coupled to the network interface, the one or more processing systems to determine, from the received set of one or more correlation vectors, a first set of data;
the one or more processing systems to generate a ray tracing model based upon the first set of data and data about objects in a vicinity of the environment, the ray tracing model describing the expected behavior of received GNSS signals in the environment;
one or more storage systems coupled to the one or more processing systems, the one or more storage systems to store the ray tracing model.

17. The data processing system as in claim 16, wherein the first set of data comprises data estimating one or more heights of one or more buildings in the environment and wherein the environment is an urban or suburban canyon that includes one or more buildings that obstruct GNSS signals from GNSS SVs.

18. The data processing system as in claim 16, wherein the first set of data includes corrections or additions to the ray tracing model, and wherein the additions include one or more amplitudes and phase data for diffractions determined from the collected set of one or more correlation vectors.

19. The data processing system as in claim 16, wherein the ray tracing model provides shadow matching assistance data that is for use in pattern matching operations to compute one or more locations of GNSS receivers in the environment.

20. The data processing system as in claim 16, wherein the first set of data includes an estimate of one or more heights of one or more buildings in the environment, the estimate of the one or more heights derived from one or more observed LOS signals and one or more observed diffraction signals in the set of one or more correlation vectors.
